(19) United States
(12) Patent Application Publication
(10) Pub. No.: US 2014/0075304 A1
(43) Pub. Date: Mar. 13, 2014

(54) ANNOTATION OF USER INTERFACE DOCUMENTS ACCORDING TO RELATED DOCUMENTATION

(71) Applicants: MATTHEW C. BAILEY, Hursley (GB); ANDREW J. DANIEL, Winchester (GB); RICHARD W. PILOT, (US); CHRISTOPHER M. WEBSTER, Winchester (GB)

(72) Inventors: MATTHEW C. BAILEY, Hursley (GB); ANDREW J. DANIEL, Winchester (GB); RICHARD W. PILOT, (US); CHRISTOPHER M. WEBSTER, Winchester (GB)

(73) Assignee: INTERNATIONAL BUSINESS MACHINES CORPORATION, ARMONK, NY (US)

(21) Appl. No.: 13/606,846

(22) Filed: Sep. 7, 2012

(51) Int. Cl. G06F 3/01

(52) U.S. Cl. 715/705

(57) ABSTRACT

Helping a user to use a first application. A help document is presented to a user. The help document describes at least one step for using the first application and includes metadata. The metadata indicates at least a first user interface element of the first application corresponding to the step. Responsive to presenting to the user the help document, based on processing of the metadata, the first user interface element is highlighted in the first application to indicate to the user to select the first user interface element to perform the step. The first user interface element is external to the help document.

### BACKGROUND

Application software, also known as an application, is computer-usable or machine-readable program code designed to be executed by a processor to help the user to perform specific tasks in a computing environment. Applications are contrasted with system software and middleware, which manage and integrate a computer's capabilities rather than applying directly to the performance of tasks that benefit the user. Applications oftentimes interact with a user interface (UI) provided by an operating system, such as a graphical user interface (GUI), to present information to a user and to receive user inputs.

### BRIEF SUMMARY

One or more embodiments disclosed within this specification relate to helping a user to use a first application.

An embodiment can include a method of helping a user to use a first application. The method includes presenting to the user a help document, the help document describing at least one step for using the first application and including metadata, the metadata indicating at least a first user interface element of the first application corresponding to the step. The method also includes, responsive to presenting to the user the help document, via a processor processing the metadata, highlighting in the first application, external to the help document, the first user interface element to indicate to the user to select the first user interface element to perform the step.

Another embodiment can include a system including a processor configured to initiate executable operations comprising. The executable operations include presenting to the user a help document, the help document describing at least one step for using the first application and including metadata, the metadata indicating at least a first user interface element of the first application corresponding to the step. The executable operations further include, responsive to presenting to the user the help document, based on processing of the metadata, highlighting in the first application, external to the help document, the first user interface element to indicate to the user to select the first user interface element to perform the step.

Another embodiment can include a computer program product for helping a user to use a first application. The computer program product includes a computer-readable storage medium having stored thereon program code that, when executed, configures a processor to perform executable operations. The executable operations include presenting to the user a help document, the help document describing at least one step for using the first application and including metadata, the metadata indicating at least a first user interface element of the first application corresponding to the step. The executable operations further include, responsive to presenting to the user the help document, based on processing the metadata, highlighting in the first application, external to the help document, the first user interface element to indicate to the user to select the first user interface element to perform the step.

### BRIEF DESCRIPTION OF THE SEVERAL VIEWS OF THE DRAWINGS

FIG. 1 is a block diagram illustrating a system for helping a user to use an application in accordance with an embodiment disclosed within this specification.

FIG. 2 depicts a window for an application and a window presenting a help document in accordance with an embodiment disclosed within this specification.

FIG. 3 is a block diagram of a processing system in accordance with an embodiment disclosed within this specification.

FIG. 4 is a flow chart illustrating a method of helping a user to use an application in accordance with an embodiment disclosed within this specification.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code embodied, e.g., stored, thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

Several definitions that apply throughout this document will now be presented.

As used herein, the term “metadata” means data contained in source code of a document that describes data and/or containers of data, and is not visible in the document when the document is rendered for viewing. In this regard, metadata can describe user interface elements.

As used herein, the term “user interface element” (“UI element”) means a user selectable element presented on a display by an application that initiates a unique programmatic action when selected by a user. Examples of user interface elements include, but are not limited to, menus, menu items, icons, controls, and widgets. UI elements are external to help documents. In other words, UI elements are not contained in help documents. Representations of the UI elements may be depicted in help documents (e.g., graphics, images, etc.) to illustrate to the user what the UI elements look like, but such representations depicted in the help documents are not the UI elements.

As used herein, the term “highlight” means to distinguish in a suitable manner. For instance, to highlight a UI element, the UI element can be presented in a color different than its default color, a background color or foreground color can be applied to the UI element, text effects or text colors can be applied to the UI element, the size of the UI element can be changed, an arrow or cursor can point to the UI element, an annotation or text can be presented with the UI element (e.g., next to the UI element), or the like. Steps described in a help document can be highlighted in a similar manner.

As used herein, the term “window” means an enclosed area presented by a graphical user interface on a display in which only a single view generated by a single instance of an executing application or utility is presented. In this regard, a window is distinct from a desktop presented by an operating system, and the window is presented on or over the desktop.

As used herein, the term “user” means a person (e.g., a human being).

The arrangements described herein relate to helping a user to use an application. More particularly, a help document is presented to a user. The help document describes one or more steps for using the application, and includes metadata. The metadata indicates UI elements of the application corresponding to the steps described in the help document. When the help document is presented to the user, the metadata can be processed to highlight in the application a UI element to indicate to the user to select the UI element to perform one of the steps described in the help document. When the user selects the UI element, additional UI elements may be presented to the user. If a next step described by the help document is to be performed by a user selection one of the additional UI elements, the appropriate UI element can be highlighted. Accordingly, the arrangements described herein facilitate use of the application by the user.

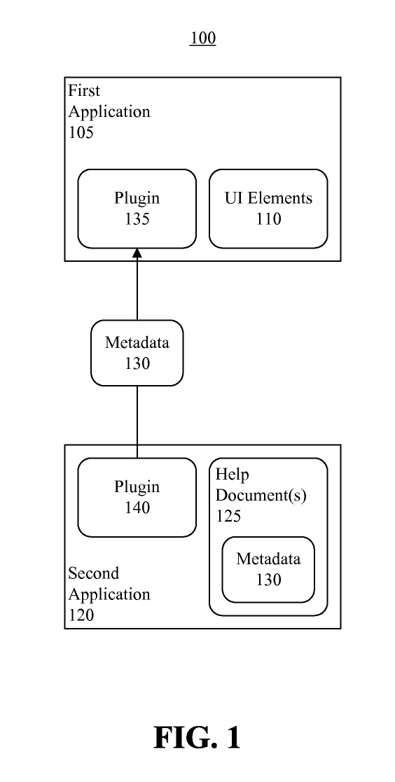

FIG. 1 is a block diagram illustrating a system 100 for helping a user to use an application in accordance with one embodiment disclosed within this specification. The system 100 can include a first application 105 that includes a plurality of UI elements 110. The first application 105 can present the UI elements 110 on a display, for instance within a window in which a user interacts with the first application 105.

The system 100 also can include a second application 120 that provides help documents 125 to guide users in using the first application 105. The second application 120 also can provide other help documents to guide users in using other applications as well. In this regard, the second application 120 can be an application that is not a component of the first application 105, although the invention is not limited in this regard.

The second application 120 can present the help document 125 to the user, for example on a display via which the user interacts with the first application 105, or another display. In one arrangement, the user can search for, or select, a particular help subject in the first application 105, and the help document 125 can be presented to the user by the second application 120 in response to such search or selection. In this regard, the second application 120 can be automatically launched in response to the user search or selection of the particular help topic. In another arrangement, the user can launch the second application 120, and the user can search for, or select, a particular help subject in the second application 120. Again, the help document 125 can be presented to the user by the second application 120 in response to such search or selection. In yet another arrangement, the second application 120 can be a web browser. The web browser can access the help document 125 from a server, such as a web server, and present the help document 125 on a suitable display, for instance in a browser window.

Alternatively, in lieu of the second application 120 presenting the help document 125, the help document 125 can be presented on the display by the first application 105. In this regard, the first application 105 can retrieve the help document 125, either from within the first application 105 itself, from files associated with the first application 105, or from another source that is not a component of the first application 105, such as a server (e.g., a web server) or another application.

Each help document 125 can describe one or more steps for using the first application 105. In illustration, a help document 125 can specify steps in which UI elements 110 are to be selected by a user to perform a specific task. The help documents 125 also can include metadata 130. In illustration, respective metadata 130 can be associated with one or more of a plurality of steps described in a help document 125. For each step, the metadata 130 can indicate a particular UI element 110 corresponding to the step. For example, the metadata 130 can indicate a particular UI element to be selected in order to perform the step, or indicate a menu of UI elements from which one or more UI elements is/are to be selected to perform the step. In one arrangement, the metadata 130 also can indicate annotations or other information to be presented with the UI elements, for example as tips or notes.

Table 1 presents an example format of metadata in accordance with an embodiment of the present arrangements.

TABLE 1
<html>
...
<head>
...
<product-steps>
<step>{PRODUCT FILE MENU}</step>
<step>{PRODUCT FILE -> NEW}</step>
<step>{NEW PROJECT DIALOG -> NEW JAVA PROJECT}</step>
<step>{NEW PROJECT DIALOG: ENTER PROJECT NAME}</step>
</product-steps>
...
</head>
...
</html>

When the help document 125 initially is presented to the user, the metadata 130 can be parsed from the help document 125 and processed to highlight in the first application 105 a UI element to indicate to the user to select the first UI element to perform a step described in the help document. For instance, the metadata 130 associated with the first step described in the help document 125 can be processed to identify the appropriate UI element 110 (e.g., first UI element 110) that should be selected by the user to perform the first step, and that UI element 110 can be highlighted to indicate to the user to select it. Responsive to the user selecting the first UI element 110, a second step described in the help document 125 can be automatically identified, and the metadata 130 associated with the second step can be processed to identify a next appropriate UI element 110 that should be selected by the user to perform the second step. Accordingly, the next UI element 110 (e.g., second UI element 110) can be highlighted to indicate to the user to select it. The first UI element 110 can remain highlighted, or highlighting of the first UI element 110 can cease after that UI element 110 is selected. Further, responsive to the user selecting the first UI element 110, the second step to which the second UI element 110 corresponds can be highlighted in the help document 125. If additional steps are described in the help document 125, the process can continue in a similar manner.

In another aspect, when a help document 125 describes a plurality of steps, and the help document 125 includes metadata 130 corresponding to two or more of these steps, the metadata 130 can be processed to create a queue comprising the plurality of steps and the UI elements 110 corresponding to the respective steps. The queue can be created, for example, using a data table. The first application 105 initially can highlight the UI element 110 corresponding to the first step. When the first UI element is selected, the first step can be marked to indicate that the first step is complete, and a second UI element corresponding to the second step can be highlighted. When the second UI element is selected, the second step can be marked to indicate the second step is complete, and a third UI element corresponding to the third step can be highlighted, and so on.

In another arrangement, each step described in the help document 125 can be user selectable. Responsive to detecting a user selection in the help document 125 one or more of the steps, the UI element(s) 110 in the first application 105 corresponding to the selected step(s) can be highlighted. For instance, when such steps are selected, the corresponding metadata 130 can be processed to identify the UI element(s) 110, initiate highlighting of the UI element(s) 110.

In some cases, when a help document 125 is presented to a user, the UI element 110 corresponding to the first step identified in the help document 125 may not be currently presented by the first application 105. For example, the first application 105 may include a menu system with a plurality of tabs, and the UI element corresponding to the first step identified in the help document 125 may be contained in a tab not currently selected. Responsive to determining that the first UI element 110 currently is not presented by the first application 105, the first application 105 can be set into a state in which the first UI element 110 is presented. For instance, the tab in which the UI element 110 is contained can be automatically selected.

To facilitate processing of the metadata 130, the first application 105 can include a plugin 135, or other application, service or module, configured to process the metadata 130 as described herein and highlight the UI elements 110. The plugin 135 also can create the queue previously described. In an arrangement in which the help document(s) 125 is/are presented by the first application 105, the plugin 135 also can parse the metadata 130 from the document(s) 125. In an arrangement in which the help document(s) 125 is/are presented by the second application 120, the second application 120 also can include a plugin 140, or other application, service or module, configured to parse the metadata 130 from the document(s) 125. In illustration, if the second application 120 is a web browser, the plugin 140 can be configured to work with the web browser.

In one aspect of the present arrangements, the help document(s) 125 can be generic in that they may also apply to applications other than the first application 105 and/or to various versions of the first application 105. In this case, the metadata 130 may contain generic information not specific to the first application 105, not specific to a currently executing version of the first application 105. In some instances, the generic information may applicable to the first application 105 in its present state. In other instances, it may not. If not, the generic information can be translated into information specific to the first application 105, or a currently executing version of the first application 105, and the plugin 135 can process the translated information to highlight the UI elements 110 as described herein. Such translation can be performed by the plugin 135, the plugin 140, or a different plugin, application, service or module (not shown) configured to perform such translation. Such different plugin, application, service or module can be executed on the same processing system on which the first application 105 is executed, though this need not be the case.

By way of example, the generic information may comprise the following information:
{PRODUCT DEFAULT SEARCH}
   This generic information can be translated to:

{MENU -> SEARCH [ID: com.ibm.
application.ui.SearchMenu] -> JAVA SEARCH [ID:
com.ibm.application.ui.SearchMenu.JavaSearchAction]}

This first example could be applicable if the first application 105 is configured to use a unique namespace related to the UI elements 110. In another example, the generic information provided in the above example can be translated to:

{MENU -> EDIT [ID: org.eclipse.menu.edit] ->
FIND [ID: org.eclipse.search]}

This second example could be applicable if the first application is configured for use with the Eclipse platform.

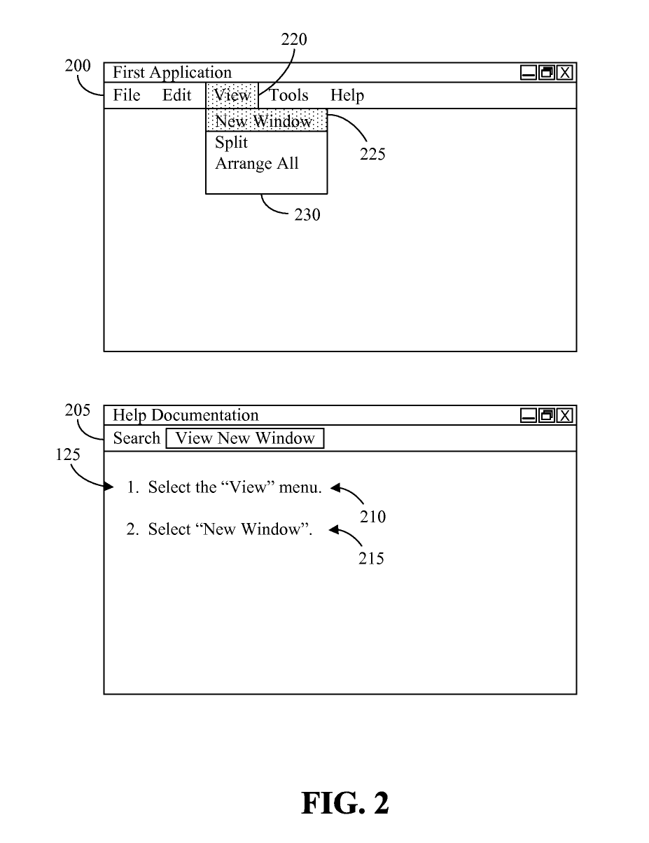

FIG. 2 depicts a window 200 for the first application 105 of FIG. 1 and a window 205 presenting the help document 125 of FIG. 1 in accordance with an embodiment disclosed within this specification. In one arrangement, the window 205 can be presented by the second application 120 of FIG. 1. In another arrangement, the window 205 can be presented by the first application 105, either separate from the window 200, or within the window 205. In another arrangement, in lieu presenting the help document 125 in the window 205, the help document 125 can be presented in a pane (not shown) of the window 200.

The help document 125 can describe one or more steps 210, 215, as noted. When the help document 125 is presented in the window 205 (or a pane), a first UI element 220, presented by the first application 105 in the window 200 and corresponding to the first step 210, can be highlighted, thus indicating to the user that the first UI element 220 corresponds to the first step 210. Alternatively, the first UI element 220 can be highlighted when the user selects the first step 210 in the help document 125.

Responsive to the user selecting the first UI element 220, or the user selecting the second step 215 in the help document 125, a second UI element 225 can be highlighted. If the second UI element 225 is contained in a menu 230 normally triggered by selection of the first UI element 220, presentation of the menu 230 can be triggered by the user selecting the first UI element 220 or by the user selecting the second step 215 in the help document 125. Of course, if the help document 125 includes additional steps (not shown), additional UI elements of the first application 105 corresponding to the additional steps can be highlighted in the same manner.

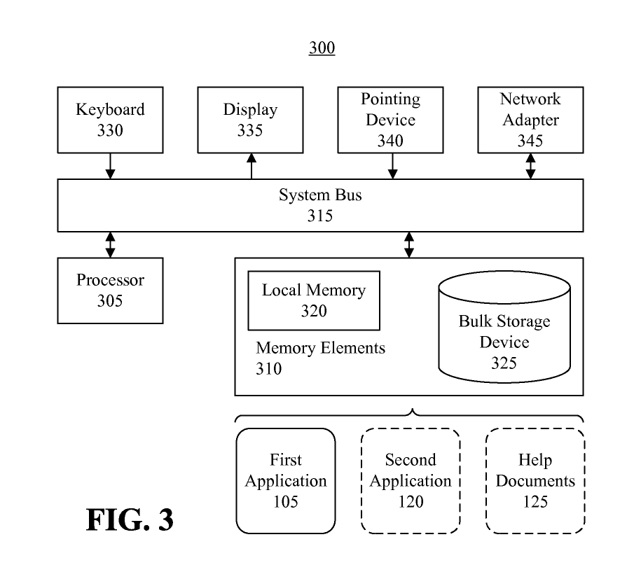

FIG. 3 is a block diagram of a processing system 300 in accordance with an embodiment disclosed within this specification. The processing system 300 can include at least one processor 305 coupled to memory elements 310 through a system bus 315 or other suitable circuitry. As such, the processing system 300 can store program code within the memory elements 310. The processor 305 can execute the program code accessed from the memory elements 310 via the system bus 315. In one aspect, for example, the processing system 300 can be implemented as a computer that is suitable for storing and/or executing program code. It should be appreciated, however, that the processing system 300 can be implemented in the form of any system including a processor and memory that is capable of performing the functions and/or operations described within this specification.

The memory elements 310 can include one or more physical memory devices such as, for example, local memory 320 and one or more bulk storage devices 325. Local memory 320 refers to RAM or other non-persistent memory device(s) generally used during actual execution of the program code. The bulk storage device(s) 325 can be implemented as a hard disk drive (HDD), solid state drive (SSD), or other persistent data storage device. The processing system 300 also can include one or more cache memories (not shown) that provide temporary storage of at least some program code in order to reduce the number of times program code must be retrieved from the bulk storage device 325 during execution.

Input/output (I/O) devices such as a keyboard 330, a display 335, and a pointing device 340 can be coupled to the processing system 300. The I/O devices can be coupled to the processing system 300 either directly or through intervening I/O controllers. One or more network adapters 345 also can be coupled to the processing system 300 to enable the processing system 300 to become coupled to other systems, computer systems, remote printers, and/or remote storage devices through intervening private or public networks. Modems, cable modems, and Ethernet cards are examples of different types of network adapters 345 that can be used with the processing system 300.

As pictured in FIG. 3, the memory elements 310 can store the first application 105. Being implemented in the form of executable program code, the first application 105, including any plugins, such as the plugin 135, can be executed by the processing system 300 and, as such, can be considered part of the processing system 300.

Optionally, the memory elements 310 also can store the second application 120. In such case, being implemented in the form of executable program code, the second application 120, including any plugins, such as the plugin 140, can be executed by the processing system 300 and, as such, can be considered part of the processing system 300. In another arrangement, the second application 120 can be executed by another processing system to which the processing system 300 is communicatively linked, for example via the network adapter 345.

Optionally, the memory elements 310 also can store the help document(s) 125. In another arrangement, the help document(s) 125 can be provided by another processing system to which the processing system 300 is communicatively linked. The processing system 300 can present UI elements of the first application 105 on the display 335 and process the metadata parsed from the help document(s) 125 to highlight the UI elements as described herein. The processing system 300 also can perform other functions/processes/operations described herein though, optionally, some functions/processes/operations can be performed by other processing systems to which the processing system 300 is communicatively linked.

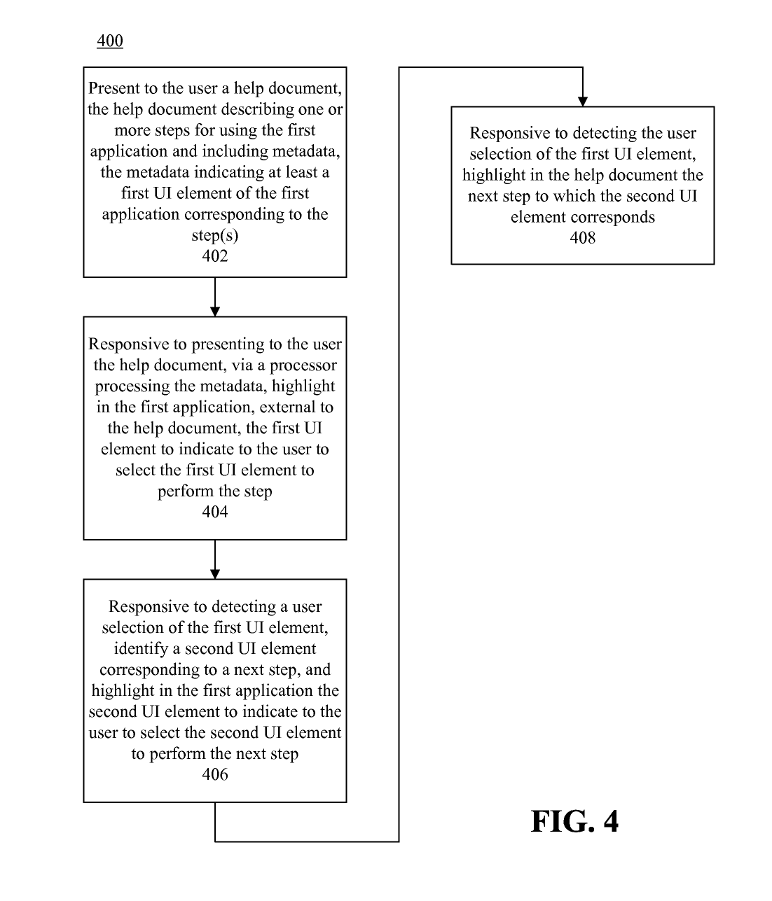

FIG. 4 is a flow chart illustrating a method 400 of helping a user to use a first application in accordance with an embodiment disclosed within this specification. At element 402, a help document is presented to the user. The help document describes one or more steps for using the first application. The help document can include metadata. The metadata can indicate at least a first UI element of the first application corresponding to the step(s).

At element 404, responsive to presenting to the user the help document, via a processor processing the metadata, the first UI element is highlighted in the first application to indicate to the user to select the first UI element to perform the step. The first UI element is external to the help document. In other words, the first UI element is not contained within the help document.

At element 406, responsive to detecting a user selection of the first UI element, a second UI element corresponding to a next step can be identified. The second UI element can be highlighted in the first application to indicate to the user to select the second UI element to perform the next step.

At element 408, responsive to detecting the user selection of the first UI element, the next step to which the second UI element corresponds can be highlighted in the help document.

Like numbers have been used to refer to the same items throughout this specification. The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof

Reference throughout this specification to “one embodiment,” “an embodiment,” or similar language means that a particular feature, structure, or characteristic described in connection with the embodiment is included in at least one embodiment disclosed within this specification. Thus, appearances of the phrases “in one embodiment,” “in an embodiment,” and similar language throughout this specification may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The corresponding structures, materials, acts, and equivalents of all means or step plus function elements in the claims below are intended to include any structure, material, or act for performing the function in combination with other claimed elements as specifically claimed. The description of the embodiments disclosed within this specification have been presented for purposes of illustration and description, but are not intended to be exhaustive or limited to the form disclosed. Many modifications and variations will be apparent to those of ordinary skill in the art without departing from the scope and spirit of the embodiments of the invention. The embodiments were chosen and described in order to best explain the principles of the invention and the practical application, and to enable others of ordinary skill in the art to understand the inventive arrangements for various embodiments with various modifications as are suited to the particular use contemplated.

What is claimed is:

1. A method of helping a user to use a first application, the method comprising:
presenting to the user a help document, the help document describing at least one step for using the first application and including metadata, the metadata indicating at least a first user interface element of the first application corresponding to the step; and
responsive to presenting to the user the help document, via a processor processing the metadata, highlighting in the first application, external to the help document, the first user interface element to indicate to the user to select the first user interface element to perform the step.

2. The method of claim 1, wherein presenting to the user the help document comprises:
presenting the help document in a second application that is not a component of the first application.

3. The method of claim 1, further comprising:
receiving the help document from a second application that is not a component of the first application.

4. The method of claim 1, wherein:
the help document describes a plurality of steps for using the first application, and the metadata indicates a plurality of user interface elements of the first application, each of the plurality of user interface elements corresponding to a respective one of the plurality of steps;
the method further comprising:
responsive to detecting a user selection of the first user interface element, identifying a second user interface element corresponding to a next of the plurality of steps, and highlighting in the first application the second user interface element to indicate to the user to select the second user interface element to perform the next step.

5. The method of claim 4, further comprising:
responsive to detecting the user selection of the first user interface element, highlighting in the help document the next step to which the second user interface element corresponds.

6. The method of claim 1, wherein:
the help document describes a plurality of steps for using the first application; and
the metadata indicates a plurality of user interface elements of the first application and, for each respective user interface element, a respective one of the plurality of steps to which the user interface element corresponds;
the method further comprising:
creating, based on the metadata, a queue comprising the plurality of steps;
identifying that the first user interface element currently is presented by the first application, and that the first user interface element corresponds to the respective one of the plurality of steps in the queue.

7. The method of claim 6, further comprising:
marking in the queue the respective one of the plurality of steps to which the first user interface element corresponds.

8. The method of claim 1, wherein:
the help document describes a plurality of steps for using the first application, and the metadata indicates a plurality of user interface elements of the first application, each of the plurality of user interface elements corresponding to a respective one of the plurality of steps;
the method further comprising:
responsive to detecting a user selection in the help document of at least one of the plurality of steps, highlighting in the first application at least one of the plurality of user interface elements corresponding to the selected step.

9. The method of claim 1, wherein highlighting in the first application the first user interface element comprises:
responsive to presenting to the user the help document, determining whether the first user interface element currently is presented by the first application;
responsive to determining that the first user interface element currently is not presented by the first application, setting the first application into a state in which the first user interface element is presented.

10. The method of claim 1, further comprising:
identifying in the metadata generic information not specific to the first application; and
translating the generic information into information specific to the first application;
wherein processing the metadata comprises processing the information specific to the first application.

11. A system comprising:
a processor configured to initiate executable operations comprising:
presenting to the user a help document, the help document describing at least one step for using the first application and including metadata, the metadata indicating at least a first user interface element of the first application corresponding to the step; and
responsive to presenting to the user the help document, based on processing of the metadata, highlighting in the first application, external to the help document, the first user interface element to indicate to the user to select the first user interface element to perform the step.

12. The system of claim 11, wherein:
the help document is presented in a second application that is not a component of the first application.

13. The system of claim 11, wherein the processor further is configured to initiate executable operations comprising:
receiving the help document from a second application that is not a component of the first application.

14. The system of claim 11, wherein:
the help document describes a plurality of steps for using the first application, and the metadata indicates a plurality of user interface elements of the first application, each of the plurality of user interface elements corresponding to a respective one of the plurality of steps; and
the processor further is configured to initiate executable operations comprising:
responsive to detecting a user selection of the first user interface element, identifying a second user interface element corresponding to a next of the plurality of steps, and highlighting in the first application the second user interface element to indicate to the user to select the second user interface element to perform the next step.

15. The system of claim 14, wherein the processor further is configured to initiate executable operations comprising:
responsive to detecting the user selection of the first user interface element, highlighting in the help document the next step to which the second user interface element corresponds.

16. The system of claim 11, wherein:
the help document describes a plurality of steps for using the first application;
the metadata indicates a plurality of user interface elements of the first application and, for each respective user interface element, a respective one of the plurality of steps to which the user interface element corresponds; and
the processor further is configured to initiate executable operations comprising:
creating, based on the metadata, a queue comprising the plurality of steps;
identifying that the first user interface element currently is presented by the first application, and that the first user interface element corresponds to the respective one of the plurality of steps in the queue.

17. The system of claim 11, wherein:
the help document describes a plurality of steps for using the first application, and the metadata indicates a plurality of user interface elements of the first application, each of the plurality of user interface elements corresponding to a respective one of the plurality of steps; and
the processor further is configured to initiate executable operations comprising:
responsive to detecting a user selection in the help document of at least one of the plurality of steps, highlighting in the first application at least one of the plurality of user interface elements corresponding to the selected step.

18. The system of claim 11, wherein the processor further is configured to initiate executable operations comprising:
responsive to presenting to the user the help document, determining whether the first user interface element currently is presented by the first application;
responsive to determining that the first user interface element currently is not presented by the first application, setting the first application into a state in which the first user interface element is presented.

19. The system of claim 11, wherein the processor further is configured to initiate executable operations comprising:
identifying in the metadata generic information not specific to the first application; and
translating the generic information into information specific to the first application;
wherein processing the metadata comprises processing the information specific to the first application.

20. A computer program product for helping a user to use a first application, the computer program product comprising:
a computer-readable storage medium having stored thereon program code that, when executed, configures a processor to perform executable operations comprising:
presenting to the user a help document, the help document describing at least one step for using the first application and including metadata, the metadata indicating at least a first user interface element of the first application corresponding to the step; and
responsive to presenting to the user the help document, based on processing the metadata, highlighting in the first application, external to the help document, the first user interface element to indicate to the user to select the first user interface element to perform the step.
